(19) United States
(12) Patent Application Publication
(10) Pub. No.: US 2025/0136472 A1
(43) Pub. Date: May 1, 2025

(54) SYSTEMS AND METHODS FOR TREATING PRODUCED WATER SOLUTIONS

(71) Applicant: Occidental Oil and Gas Corporation, Houston, TX (US)

(72) Inventors: Marshall A. PICKARTS, Cypress, TX (US); David N. HARRY, Katy, TX (US); Joseph DeALMEIDA, Richmond, TX (US); Anoop V. CHENGARA, Iowa Colony, TX (US); Vrajesh Sanat MEHTA, Richmond, TX (US)

(21) Appl. No.: 18/934,647

(22) Filed: Nov. 1, 2024

Related U.S. Application Data
(60) Provisional application No. 63/597,569, filed on Nov. 9, 2023.
(60) Provisional application No. 63/595,294, filed on Nov. 1, 2023.

(51) Int. Cl. C02F 1/04; C02F 103/10; E21B 43/20

(52) U.S. Cl. CPC C02F 1/048; C02F 1/041; E21B 43/20; C02F 2103/10; C02F 2301/08

(57) ABSTRACT

A multi-stage process for treating a salt solution, the process comprising (i) providing an initial salt solution to an initial distillation stage, (ii) distilling the initial salt solution within the initial distillation stage to thereby produce an initial vapor stream and an initial concentrated salt solution, where said initial distillation stage takes place at pressure above atmospheric pressure; (iii) transferring the initial vapor stream and initial concentrated salt solution to an intermediary distillation stage; (iv) condensing the initial vapor stream to thereby release the heat of condensation associated with the initial stream; (v) converting, within the intermediary distillation stage, at least a portion of the initial concentrated salt solution an intermediary vapor stream and an intermediary concentrated salt solution; (vi) transferring the intermediary vapor stream and intermediary concentrated salt solution to a final distillation stage, wherein the final distillation stage produces a final vapor stream and a final concentrated salt solution; (vii) condensing at least a portion of the final vapor stream to thereby release the heat of condensation associated with the final vapor stream; (viii) transferring at least a portion of the heat of condensation associated with the final vapor stream to the initial salt solution; and (ix) capturing at least a portion of the final concentrated salt solution.

This application claims the benefit of U.S. Provisional Application No. 63/595,294 filed on Nov. 1, 2023, and U.S. Provisional Application No. 63/597,569 filed on Nov. 9, 2023, which are incorporated herein by reference.

### FIELD OF THE INVENTION

Embodiments of the invention are directed toward systems and methods for treating brine waters produced from oil and gas wells.

### BACKGROUND OF THE INVENTION

Water associated with the production of oil and gas is referred to as produced oilfield water or simply produced water. Produced water is generally classified as flowback water or formation water. Flowback water includes spent hydraulic fracturing (frac) fluid, which includes water and related additives used to hydraulically fracture the formation. Formation water includes water that was originally present in the formation. Generally, the relative amount of formation water increases as the amount of flowback water decreases.

The volume of produced water is significant because it is typical to produce multiple barrels of water per barrel of oil produced. In fact, it is not uncommon to produce four to eight barrels of water per barrel of oil produced in some formations. As a result, some oil fields generate tens of millions of barrels of water each day. Some of this water can be reused, especially where water flooding or enhanced oil recovery (EOR) techniques are employed. Nonetheless, an increasing amount of water must be disposed of. The handling and disposal costs associated with produced water can significantly impact the economic viability of any given oil production play.

In addition to the large volume of produced water, other issues associated with produced water complicate its handling and ultimate disposition. For example, the chemical nature of produced water is very complex and can vary based upon the nature of the formation and the production techniques employed. Produced waters generally include significant levels of dissolved and suspended salts in addition to hydrocarbons and gases such as hydrogen sulfide. For example, produced water can include greater than 100,000 mg/L of salt, and can therefore include more than three times the amount of salt found in seawater. In view of the total solids contained in produced water, costly disposal techniques are often required, and these costs are further aggravated by the volume of water that must be managed.

### SUMMARY OF THE INVENTION

One or more embodiments of the present invention provide a multi-stage process for treating a salt solution, the process comprising (i) providing an initial salt solution to an initial distillation stage, (ii) distilling the initial salt solution within the initial distillation stage to thereby produce an initial vapor stream and an initial concentrated salt solution, where said initial distillation stage takes place at pressure above atmospheric pressure; (iii) transferring the initial vapor stream and initial concentrated salt solution to an intermediary distillation stage; (iv) condensing the initial vapor stream to thereby release the heat of condensation associated with the initial stream; (v) converting, within the intermediary distillation stage, at least a portion of the initial concentrated salt solution an intermediary vapor stream and an intermediary concentrated salt solution; (vi) transferring the intermediary vapor stream and intermediary concentrated salt solution to a final distillation stage, wherein the final distillation stage produces a final vapor stream and a final concentrated salt solution; (vii) condensing at least a portion of the final vapor stream to thereby release the heat of condensation associated with the final vapor stream; (viii) transferring at least a portion of the heat of condensation associated with the final vapor stream to the initial salt solution; and (ix) capturing at least a portion of the final concentrated salt solution.

Other embodiments of the present invention provide a system for treating a salt solution, the system comprising (i) a first distillation tank, where said first distillation tank is adapted for pressure regulation and includes an inlet for receiving a salt solution, an outlet for removing a first concentrated salt solution, and an outlet for removing vapor, where said first distillation tank operates at pressures above atmospheric pressure; (ii) a second distillation, where said second distillation tank is adapted for pressure regulation and includes an inlet for receiving a concentrated salt solution, an outlet for removing a concentrated salt solution, and an outlet for removing vapor, where said second distillation tank is downstream of said first distillation tank, and where said second distillation tank operates at pressures below atmospheric pressure; (iii) a first heat exchanger in thermal communication with the first distillation tank; (iv) a second heat exchanger in thermal communication with the second distillation tank; and (v) a first eductor in fluid communication with the second distillation tank, where said first eductor includes an inlet for receiving a liquid motive fluid, an inlet for receiving vapor from the second distillation tank, and an outlet for removing a first heated fluid stream from the first eductor, where the first eductor is adapted to mix vapor from the second distillation tank into the motive fluid to thereby condense the vapor to produce the first heated liquid stream, where outlet for removing a first heated fluid stream is in fluid communication with said first heat exchanger.

Yet other embodiments of the present invention provide a method of managing a salt solution, the method comprising (i) providing an initial salt solution; (ii) partially distilling the salt solution to provide a distillate stream and a concentrated salt solution; and (iii) directing the concentrated salt solution to downstream handling.

Still, other embodiments of the present invention provide a multi-stage process for treating a salt solution, the process comprising (i) providing an initial salt solution to an initial distillation stage, (ii) distilling the initial salt solution within the initial distillation stage to thereby produce an initial vapor stream and an initial concentrated salt solution, where said initial distillation stage takes place at pressure above atmospheric pressure; (iii) transferring the initial vapor stream and initial concentrated salt solution to an intermediary distillation stage; (iv) condensing the initial vapor stream to thereby release the heat of condensation associated with the initial stream; (v) converting, within the intermediary distillation stage, at least a portion of the initial concentrated salt solution an intermediary vapor stream and an intermediary concentrated salt solution; (vi) transferring the intermediary vapor stream and intermediary concentrated salt solution to a final distillation stage, wherein the final distillation stage produces a final vapor stream and a final concentrated salt solution, where said final distillation stage takes place at pressures below atmospheric pressure; and (vii) condensing the final vapor stream to thereby release the heat of condensation associated with the final vapor stream.

### BRIEF DESCRIPTION OF THE DRAWINGS

FIG. 1 is a schematic diagram of a pressurized multi-stage distillation system according to embodiments of the present invention.

FIG. 2 is a schematic diagram of a multi-stage distillation system including an initial distillation stage operating above atmospheric pressure and a final distillation stage operating below atmospheric pressure according to embodiments of the present invention.

FIG. 3 is a schematic diagram of a water management system according to embodiments of the present invention.

### DETAILED DESCRIPTION OF ILLUSTRATIVE EMBODIMENTS

Embodiments of the present invention are based, at least in part, upon the discovery of distillation systems and related methods for concentrating salt solutions. In one or more embodiments, the salt solutions are concentrated by partially distilling the salt solutions within distillation systems that include multiple stages of distillation. In one or more embodiments, the initial distillation stage operates above atmospheric conditions. In one or more embodiments, one or more of the subsequent stages operates at or near atmospheric conditions. In some embodiments, one or more of the subsequent stages operates below atmospheric conditions.

In one or more embodiments, systems and methods of the invention are employed to manage produced water (i.e. water co-produced with oil and gas production operations). These methods include partially distilling the produced water to produce a highly concentrated aqueous residue stream that can be subsequently managed. In other words, the distillation process produces a concentrated salt solution (i.e. residue stream) that includes a higher dissolved solids content than the produced water stream. Since produced water is often a waste stream that must be managed accordingly, the present invention advantageously provides an efficient solution to managing these waste streams by reducing the overall volume of the salt solution that must be managed. For example, where the concentrated salt solutions are disposed of, the systems and methods of the invention advantageously reduce disposal costs and other disadvantages associated with disposal. Or, given the concentration of the salts within the concentrated salt solutions, the concentrated salt solutions may themselves have value above that of the initially produced water; for example, the concentrated salt solutions may provide an attractive opportunity to separate and capture certain metal ions such as lithium or rare earth metal ions. Additionally, while the produced water streams are concentrated into concentrated salt solutions, the processes employed in one or more embodiments of the invention are manipulated to ensure that the concentrated salt solutions remain below threshold levels for total solids to ensure the ability to handle the concentrated streams in a desired manner.

### Brine Solutions to be Treated

Systems and methods described herein may be described with reference to the solutions that are treated according the invention. While further description of the various solutions is provided below, it should be appreciated that the solutions may be referred to as salt solutions because the solutions are aqueous and include dissolved solids. Relative to the systems and methods disclosed herein, the salt solutions may also be referred to as brine water or saline solutions, and therefore it should be appreciated that the terms may be used interchangeably unless otherwise stated. It should also be appreciated that upon treatment of these salt solutions by the systems and methods of the invention, concentrated salt solutions are produced, which concentrated solutions may be also be referred to as concentrated brines or concentrated saline solutions.

### Pressurized Distillation—Multi-Stage Systems

As suggested above, in one or more embodiments, salt solutions are concentrated by employing multi-stage distillation systems that include at least one stage operating above atmospheric conditions. Generally, the multi-stage systems include a first stage (which may also be referred to as an initial stage), where a brine solution is distilled to produce a vapor stream and a concentrated brine solution stream. The vapor is condensed and at least a portion of the heat of condensation is transferred to the concentrated brine solution stream in an intermediary stage. Distillation takes place in the intermediary stage to produce an intermediate vapor stream and an intermediate concentrated brine solution stream. The vapor produced in the intermediary stage is condensed and at least a portion of the heat of condensation is transferred to the intermediate concentrated brine solution stream in a downstream stage where distillation again takes place to produce another vapor stream and another concentrated brine solution stream (for two-stage systems, the vapor and associated heat of condensation passes directly from the initial to the final stage). At the final stage, the vapor stream received by the final stage is at least partially condensed, for example within a fan-driven heat exchanger, and at least a portion of the heat of condensation associated with the vapor stream received by the final stage is transferred back to the initial stage. The intermediary stage may include multiple substages where distillation takes place in multiple substages operating in series with each successive substage producing a vapor stream and a concentrated brine solution stream, and condensation of the vapor stream releases heat of condensation that is at least partially transferred to the subsequent substage. This process may also be referred to as multi-effect distillation.

### First Embodiment

In a first set of embodiments, the multi-stage distillation processes of the present invention take place over a pressure continuum that includes one or more stages operating at pressures above atmospheric pressure. For example, one or more embodiments may include an initial distillation stage operating above atmospheric pressure and a final distillation stage operating at or near atmospheric pressure. This process may include one or more intermediary stages operating at pressures cascading down from the initial stage toward atmospheric pressure. The multi-stage distillation systems of these embodiments, which include one or more stages operating above atmospheric pressure, advantageously induce relatively small vapor volume and therefore the ability to employ smaller piping, systems having less weight, and reduced overall footprint. For example, in one or more embodiments, the system is adapted for transport and use on traditional flatbed trailer. Additionally, by maintaining higher pressures, volatiles, such as ammonia, are retained at higher concentrations in the in the liquid streams, which reduces or eliminates downstream treatment of the distillate stream.

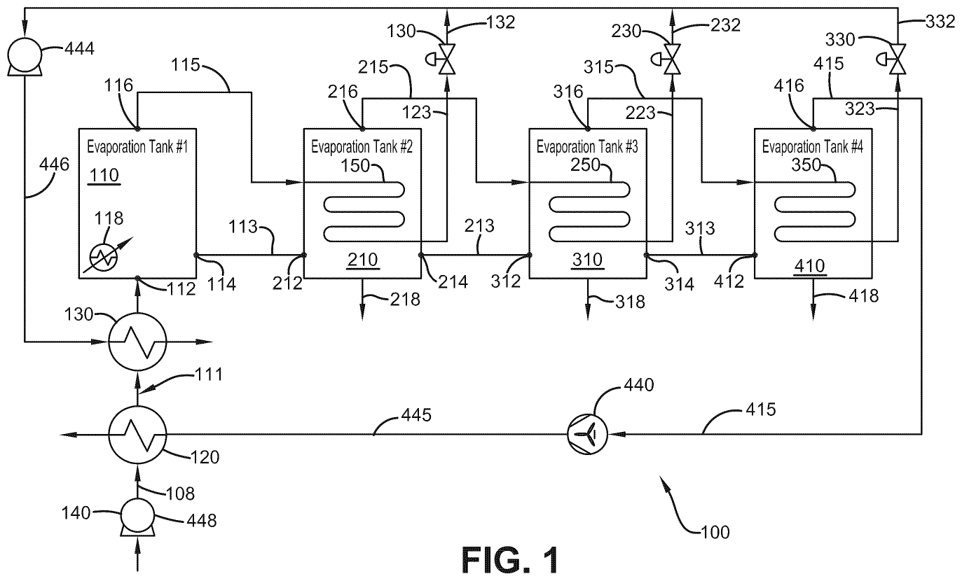

An exemplary multi-stage distillation system can be described with reference to FIG. 1. As shown, multi-stage system 100 includes four stages represented by a first distillation tank 110, a second distillation tank 210, a third distillation tank 310, and a fourth distillation tank 410. The distillation tanks may be referred to as evaporation tanks or simply tanks. In one or more embodiments, the distillation tanks disclosed herein are adapted to include an internal chamber that is or can be sufficiently sealed to allow for regulation of the pressure within the chamber.

Distillation tanks 110, 210, 310, 410 each include liquid inlets 112, 212, 312, and 412, respectively, and vapor outlets 116, 216, 316, and 416, respectively. Distillation tanks 110, 210, and 310 each include liquid outlets 114, 214, and 314, respectively, and distillation tanks 210, 310, and 410 each respectively include concentrated brine outlets 218, 318, and 418. In one or more embodiments, tank 110 may also have an outlet (not shown) to remove concentrated brine from the system.

First distillation tank 110 is in fluid communication with second distillation tank 210 via conduit 113, second distillation tank 210 is in fluid communication with third distillation tank 310 via conduit 213, and third distillation tank 310 is in fluid communication with fourth distillation tank 410 via conduit 313. Tank 110 is also in fluid communication with first control valve 130. Tank 210 is also in fluid communication with second control valve 230. Tank 310 is also in fluid communication with third control valve 330. And tank 410 is also in fluid communication with fan 440.

Control valve 130 is in fluid communication with conduits 123 and 132. Second control valve 230 is in fluid communication with conduits 223 and 232. Third control valve 330 is in fluid communication with conduits 323 and 332. Conduits 132, 232, and 332 combine to feed pump 444, which is in fluid communication with heat exchanger 130. Heat exchanger 130 is in thermal communication with inlet brine solution carried by conduit 111.

Fan 440 is in fluid communication with conduits 415 and 445, as well as heat exchanger 120. Heat exchanger 120 is in thermal communication with inlet brine carried by conduit 108.

A vapor-line radiator system 150 is disposed within second distillation tank 210, and radiator system 150 is in fluid communication with first distillation tank 110 via conduit 115 and with control valve 130 via conduit 123. A second vapor-line radiator system 250 is disposed within third distillation tank 310, and radiator system 250 is in fluid communication with second distillation tank 210 via conduit 215 and with control valve 230 via conduit 223. A third vapor-line radiator system 350 is disposed within fourth distillation tank 410, and radiator system 350 is in fluid communication with third distillation tank 310 via conduit 315 and with control valve 330 via conduit 323. The radiators or radiator systems may be referred to as heat exchangers. In one or more embodiments, the radiators include a conduit or coil through which the distillate flows, cools, and is condensed. The conduit or coils generally include an elongated body that offers desirable surface area and contact with the fluids within the tank in which the radiator is disposed.

During operation, a brine solution is introduced to first distillation tank 110 at liquid inlet 112 via feed line 111. As will be described in greater detail below, the brine is optionally pre-heated within heat exchanger 120 and heat exchanger 130. The flow of brine solution into first distillation tank 110, which flow is promoted by pump 140, is regulated to create a liquid level within tank 110 and a head space above the liquid level. The brine can be further heated by heat transferred from utility heater 118. The temperature of the brine, which is achieved by heat transferred from heat exchangers 120, 130, and optionally utility heater 118, is regulated to separate a portion of the water in the form of vapor from the remaining brine (i.e. distill water from the brine). Stated differently, temperature and pressure within tank 110 drive distillation of the brine solution, and the distillate (i.e. vapor) enters the head space within tank 110. As noted above, the distillate within the head space is in fluid communication with valve 130 via vapor outlet 116, conduit 115, radiator 150, and conduit 123. By operating valve 130 in a desired manner (e.g. by restricting flow), distillation of the brine within tank 110 takes place at higher temperature and pressure (i.e. pressures above atmospheric pressure). The elevated pressure within distillation tank 110 provides a driving force for the fluid to pass through valve 130 into conduit 132, which is at atmospheric pressure. In other words, the differential pressure between the operating pressure of distillation tank 110 and atmospheric pressure within conduit 132 provides a motive force to transfer fluid from tank 110, through conduit 115, through radiator 150, through conduit 123, through valve 130, and into conduit 132.

As the vapor passes through radiator system 150, heat associated with the vapor is transferred to the fluid within tank 210, which causes the vapor to condense. The heat transferred to the fluid within tank 210 therefore includes the latent heat associated with the vapor. The skilled person will understand that the condensation of the vapor within radiator 150 will provide a pressure drop within radiator 150, which will further facilitate transfer of the vapor stream from tank 110. The residue within tank 110, which is concentrated brine, is removed from tank 110 via liquid outlet 114 via conduit 113, and it is then transferred from first distillation tank 110 to second distillation tank 210. As with tank 110, the transfer of concentrated brine to distillation tank 210 creates a liquid level and a head space within second distillation tank 210.

As noted above, heat associated with the vapor leaving tank 110 is transferred to the concentrated brine within tank 210 via radiator 150. In other words, radiator 150 is in thermal communication with the concentrated brine within second distillation tank 210. This heat includes the latent heat associated with the condensation of vapor removed from first distillation tank 110. The temperature of the liquid within distillation tank 210 drives separation of the water vapor from the remaining brine. That is, the temperature of the brine within tank 210 is increased to drive further distillation of the concentrated brine, and the distillate (i.e. vapor), which is in the head space of tank 210, is removed through vapor outlet 216. The residue, which is concentrated brine, is removed from tank 210 via concentrated brine outlet 214 via conduit 213 and transferred to third distillation tank 310.

In a similar fashion to the operation of tank 110, distillate within the head space of tank 210 is in fluid communication with valve 230 via vapor outlet 216, conduit 215, radiator 250, and conduit 223. Pressure within tank 210, which is regulated by valve 230, drives the vapor into radiator 250, which is in thermal communication with the fluid within tank 310. The vapor condenses within radiator 250 and heat, including latent heat, associated with the vapor stream is at least partially transferred to the fluid within tank 310. This heat drives further distillation of the concentrated brine within tank 310. As with radiator 150, condensation of the vapor within radiator 250 will provide a pressure drop within radiator 250, which will further facilitate transfer of the vapor stream from tank 210. Pressure from tank 210 otherwise drives the fluid within radiator 250 and conduit 223 through valve 230 to atmospheric pressure within conduit 232. The pressure within tank 210 is regulated by valve 230. The condensed vapor passes through valve 230 into conduit 232, which is at atmospheric pressure. The residue within tank 210, which is a concentrated brine, can be transferred to third distillation tank 310 via outlet 214, conduit 213, and inlet 312.

A similar process takes place with respect to the concentrated brine transferred to third distillation tank 310. As noted above, heat is transferred from the fluid within radiator 250 to the brine within tank 310, which further distills the brine within tank 310. Distillate enters the head space of tank 310 and pressure, which is regulated by valve 330, drives the vapor through vapor outlet 316 into conduit 315, into radiator 350, into conduit 323, through valve 330, and into conduit 332, which is maintained near or above atmospheric pressure.

The concentrated brine transferred to distillation tank 410 is further heated by heat transferred from the fluid within radiator system 350, which drives further distillation of the brine within tank 410. This heat, together within the control of pressure caused by fan 440, drives further distillation of the concentrated brine within tank 410, and the distillate (i.e. vapor) is removed from the head space through vapor outlet 416 into conduit 415. As shown, the vapor can be forced, with the assistance of fan 440, through heat exchanger 120, where the heat associated with the vapor, including latent heat, can be transferred to the incoming brine within conduit 108. The remaining stream carried by conduit 415, which primarily includes distilled water, steam or a mixture of both depending on the incoming brine volume and temperature, can be routed downstream and, for example, released to the atmosphere if in the form of steam or used as a clean liquid water where desired.

Condensed fluid within conduits 132, 232, and 332 can be aggregated and, with the optional assistance of pump 444, transferred to heat exchanger 130 where heat associated with the condensed stream can be transferred to incoming brine carried by conduit 111. The stream can then be transferred to wherever clean water is desired.

Depending on the desired concentration of the concentrated brine, the concentrated brine can be removed from system 100 via outlet 218, 318, and/or 418, and it can then be routed to downstream uses or disposal as described herein. The location at which it may be desirable to remove the concentrated brine from the brine concentration system may depend on several factors including, but not limited to, the total solids (both dissolved and suspended) within the concentrated brine at any given location. In this regard, each distillation tank may include a device to monitor one or more properties of the brine to ascertain the total solids and/or one or more other relevant properties such as viscosity. Removal of the brine through one or more of the discharge outlets may take place, based upon data gathered relative to the brine, by decisions made in real time, or via a pre-selected program. It will also be appreciated that volatiles within the salt solution introduced to the system may be volatilized at any of the given stages (i.e. transferred by conduits 115, 215, 315, and/or 415), and/or the volatile compounds can be retained in the concentrated stream (i.e. transferred by conduits 113, 213, 313 and/or 418).

According to embodiments of the invention, as the concentration of the brine increases with each stage (i.e. as the concentrated brine solution is transferred to each successive distillation tank), the conditions required to distill the solution increase by requiring higher temperatures or reduced pressure. In one or more embodiments, the temperature of the solution within each successive tank decreases and the pressure within each successive tank decreases. Stated differently, the temperature of the initial distillation tank can be represented by Tᵢₙᵢₜᵢₐₗ and the pressure within initial distillation tank can be represented by Pᵢₙᵢₜᵢₐₗ; the temperature of the intermediary distillation tanks (collectively) can be represented by T_{intermediary} and the pressure within the intermediary distillation tanks (collectively) can be represented by P_{intermediary}; the temperature of the final distillation tank can be represented by T_{final}, the pressure within the final distillation tank can be represented by P_{final}, and during operation of the system, Tᵢₙᵢₜᵢₐₗ>T_{intermediary}>T_{final} and Pᵢₙᵢₜᵢₐₗ>P_{intermediary}>P_{final}. In one or more of these embodiments, Pᵢₙᵢₜᵢₐₗ and P_{intermediary} are above atmospheric pressure, and P_{final} is at or near atmospheric pressure. In other embodiments, Pᵢₙᵢₜᵢₐₗ, P_{intermediary}, and P_{final} are all above atmospheric pressure. Where the intermediary stage includes multiple substages (i.e. multiple distillation tanks in series with heat of condensation and concentrated brine transferred successively downstream to the tanks in series), the temperature and pressure at the first substage can be represented as T₁ and P₁, respectively, and each successive stage as T₁₊ₙ and P₁₊ₙ, respectively, where n represents the number of the sub-stage beyond the first substage. Accordingly, during operation of the system, the temperature and pressure profile within the intermediary stage can be defined as T₁>T₁₊ₙ and P₁>P₁₊ₙ, with n being an integer representing each successive substage beyond the first and continuing in series for each additional substage.

In one or more embodiments, Pᵢₙᵢₜᵢₐₗ is greater than 10, in other embodiments greater than 20, in other embodiments greater than 30, and in other embodiments greater than 40 psig. In these or other embodiments, Pᵢₙᵢₜᵢₐₗ is from about 15 to about 50, in other embodiments from about 20 to about 45, and in other embodiments from about 30 to about 40 psig. In one or more embodiments, the change in temperature between successive stages, which change may be represented by ΔT, is from about 1 to about 20, in other embodiments from about 5 to about 15, and in other embodiments from about 8 to about 12° C. between each stage of the process.

### Second Embodiment

In a second set of embodiments, the multi-stage distillation processes of the present invention take place over a pressure continuum that includes pressures above and below atmospheric pressure. For example, one or more embodiments may include an initial distillation stage operating above atmospheric pressure and a final distillation stage operating below atmospheric pressure (i.e. under vacuum). This process may include one or more intermediary stages operating at pressures cascading down from the initial stage toward atmospheric pressure. This process may also include one or more intermediary stages operating at pressures below atmospheric pressure and cascading down toward the pressure of the final stage. This process may also include a stage at or near atmospheric pressure. The stage or stages operating below atmospheric pressures may operate based upon an eductor-based vacuum design. The multi-stage distillation systems of these embodiments, which operate over a broad continuum above and below atmospheric pressure, advantageously expand the operational envelope of the process to cover a greater range of achievable pressures. This advantageously allows for either the realistic addition of more stages to the process (i.e., greater heat recapture efficiency) or greater thermal driving forces between stages to reduce equipment sizing (i.e., lower capital expenditures).

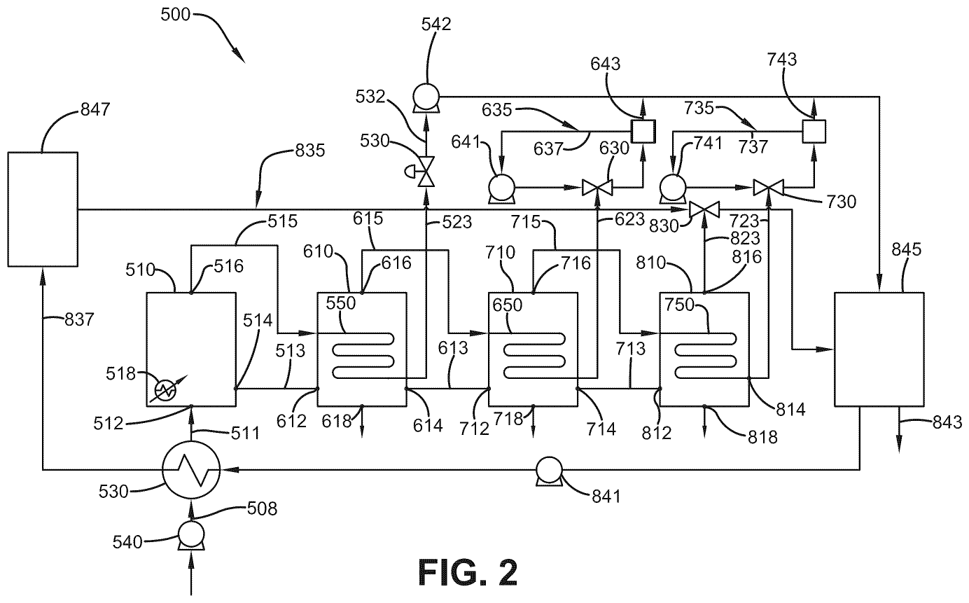

An exemplary multi-stage distillation system that includes one or more stages operating above atmospheric pressure and one or more stages operating below atmospheric pressure can be described with reference to FIG. 2. As shown, multi-stage system 500 includes four stages represented by a first distillation tank 510, a second distillation tank 610, a third distillation tank 710, and a fourth distillation tank 810. As with other embodiments, the distillation tanks may be referred to as evaporation tanks or simply tanks, and the distillation tanks may be adapted to include an internal chamber that is or can be sufficiently sealed to allow for regulation of the pressure within the chamber.

Distillation tanks 510, 610, 710, and 810 each include liquid inlets 512, 612, 712, and 812, respectively, and vapor outlets 516, 616, 716, and 816, respectively. Distillation tanks 510, 610, and 710 each include liquid outlets 514, 614, and 714, respectively, and distillation tanks 610, 710, and 810 each respectively include concentrated brine outlets 618, 718, and 818. In one or more embodiments, tank 510 may also have an outlet (not shown) to remove concentrated brine from the system.

First tank 510 is in fluid communication with control valve 530. Specifically, tank 510 includes a vapor outlet 516 in fluid communication with conduit 515, which is in fluid communication with radiator 550, which is in fluid communication with conduit 523, which is in fluid communication with valve 530.

Second tank 610 is in fluid communication with a liquid-liquid eductor 630. Specifically, tank 610 includes a vapor outlet 616 in fluid communication with conduit 615, which is in fluid communication with radiator 650, which is in fluid communication with conduit 623, which is in fluid communication with liquid-liquid eductor 630. Third tank 710 is in fluid communication with a liquid-liquid eductor 730. Specifically, tank 710 includes a vapor outlet 716 in fluid communication with conduit 715, which is in fluid communication with radiator 750, which is in fluid communication with conduit 723, which is in fluid communication with liquid-liquid eductor 730. Fourth tank 810 is fluid communication with condensing vapor-liquid eductor 830 via outlet 816 and conduit 823.

Liquid-liquid eductor 630, which may simply be referred to as eductor 630, is in fluid communication with motive loop 635, which includes conduit 637, pump 641, and liquid outlet 643. Similarly, liquid-liquid eductor 730, which may simply be referred to as eductor 730, is in fluid communication with motive loop 735, which includes conduit 737, pump 741, and liquid outlet 743. Condensing vapor-liquid eductor 830, which may simply be referred to as eductor 830, is in fluid communication with motive loop 835, which includes conduit 837, pump 841, liquid outlet 843, storage tank 845, and a cooler 847. Conduit 837 and a produced water inlet line 511 are in thermal communication via heat exchanger 530.

The eductors, which are also commonly referred to as ejectors, jet pumps, or jet compressors, are known in the art and generally include those devices that produce vacuum or suction through the Venturi effect as a liquid, which may be referred to as a motive fluid, is forced through a constriction within the eductor. The skilled person appreciates that an eductor includes a liquid inlet, a suction inlet, and liquid outlet. The eductor receives a liquid motive fluid through its liquid inlet and draws gases or liquids (e.g. water or vapor) through its suction inlet. Where the fluid being drawn into the eductor is gas, the gas is condensed, and the eductor mixes the condensate with the motive fluid, and the mixture of the motive fluid and the condensate is then expelled through the liquid outlet of the eductor. The skilled person appreciates that where the eductor condenses a vapor, the eductor may be referred to as a condensing liquid-vapor eductor. Where the eductor draws liquid through its suction inlet, the eductor may be referred to as a liquid-liquid eductor. In other words, a liquid-liquid eductor is adapted to receive a liquid motive fluid and draw liquid from a distinct source into the eductor and mix the drawn liquid with the motive fluid.

During operation, a brine solution is introduced to first distillation tank 510 at liquid inlet 512 via feed line 511. As will be described in greater detail below, the brine is optionally pre-heated within heat exchanger 530. The flow of brine solution into first distillation tank 510, which flow is promoted by pump 540 via conduit 508, is regulated to create a liquid level within tank 510 and a head space above the liquid level. The brine can be further heated by heat transferred from utility heater 518. The temperature of the brine, which is achieved by heat transferred from heat exchangers 530 and optionally utility heater 518 is regulated to separate a portion of the water in the form of vapor from the remaining brine (i.e. distill water from the brine). Stated differently, temperature and pressure within tank 510 drive distillation of the brine solution, and the distillate (i.e. vapor) enters the head space within tank 510. As noted above, the distillate within the head space is in fluid communication with valve 530 via vapor outlet 516, conduit 515, radiator 550, and conduit 523. By operating valve 530 in a desired manner (e.g. by restricting flow), distillation of the brine within tank 510 takes place at higher temperature and pressure (i.e. pressures above atmospheric pressure). The elevated pressure within distillation tank 510 provides a driving force for the fluid to pass through valve 530 into conduit 532, which is at atmospheric pressure. In other words, the differential pressure between the operating pressure of distillation tank 510 and atmospheric pressure within conduit 532 provides a motive force to transfer fluid from tank 510, through conduit 515, through radiator 550, through conduit 523, through value 530, and into conduit 532. With the assistance of pump 542, the fluid within conduit 532 can be transferred to a storage tank 845 and ultimately transferred from the system via conduit 843.

The residue within tank 510, which is concentrated brine, is removed from tank 510 via liquid outlet 514 via conduit 513, and transferred to second distillation tank 610 via inlet 612. As with tank 510, the transfer of concentrated brine into distillation tank 610 creates a liquid level and a head space within second distillation tank 610. As the vapor passes through radiator system 550, heat associated with the vapor is transferred to the fluid within second tank 610, which causes the vapor to condense. The heat transferred to the fluid within tank 610 therefore includes the latent heat associated with the vapor. The skilled person will understand that the condensation of the vapor within radiator 550 will provide a pressure drop within radiator 550, which will further facilitate transfer of the vapor stream from tank 510.

As noted above, heat associated with the vapor leaving tank 510 is transferred to the concentrated brine within tank 610 via radiator 550. This heat includes latent heat associated with the condensation of vapor removed from first distillation tank 510. The temperature of the liquid within distillation tank 610 drives separation of the water vapor from the brine within tank 610. That is, the temperature of the brine within tank 610 is increased to drive further distillation of the concentrated brine, and the distillate (i.e. vapor), which is in the head space of tank 610, is removed through vapor outlet 616. The residue within tank 610, which is concentrated brine, is removed from tank 610 via concentrated brine outlet 614 and conduit 613 and transferred to third distillation tank 710 via inlet 712.

Because distillate within the head space of tank 610 is in fluid communication with eductor 630, distillation within tank 610 takes place at reduced pressures (e.g. temperatures below atmospheric pressure). A motive fluid, such as water, is circulated through motive loop 635 at a desired pressure that is regulated by pump 641. As the motive fluid is forced through eductor 630, the operation of the eductor creates a partial vacuum that draws fluid from vapor-line radiator system 650 (i.e. liquid condensed within radiator system 650 is drawn through conduit 623). The liquid drawn from radiator 650 is entrained into the motive fluid and becomes part of the motive fluid circulating through loop 635. As liquid water is drawn from radiator 650, vapor is drawn from the headspace of tank 610 into radiator 650. The skilled person will appreciate that the condensation of the vapor within radiator 650 maintains reduced pressure within tank 610, which draws vapor into radiator 650 and facilitates distillation within tank 610 (by reducing pressure within tank 610). The skilled person will also appreciate that removal of liquid water from radiator 650 via eductor 630 will replenish the surface area within radiator 650 and allow condensation of the subsequent vapor entering radiator 650 to occur. In any event, the amount of liquid within circulation loop 635 is regulated by withdrawal of fluids through outlet 643.

Similarly, distillate within the head space of tank 710 is in fluid communication with eductor 730, and distillation within tank 710 takes place at reduced pressures. Specifically, a motive fluid, such as water, is circulated through motive loop 735 at a desired pressure that is regulated by pump 741. As the motive fluid is forced through eductor 730, the operation of the eductor creates a partial vacuum that draws fluid from vapor-line radiator system 750 (i.e. liquid condensed within radiator system 750 is drawn through conduit 723). The liquid drawn from radiator 750 is entrained into the motive fluid and becomes part of the motive fluid circulating through loop 735. As liquid water is drawn from radiator 750, vapor is drawn from the headspace of tank 710 into radiator 750. The skilled person will appreciate that the condensation of the vapor within radiator 750 maintains reduced pressure within tank 710, which draws vapor into radiator 750 and facilitates distillation within tank 710 (by reducing pressure within tank 710). The skilled person will also appreciate that removal of liquid water from radiator 750 via eductor 730 will replenish the surface area within radiator 750 and allow condensation of the subsequent vapor entering radiator 750 to occur. In any event, the amount of liquid within circulation loop 735 is regulated by withdrawal of fluids through outlet 743.

Similarly, a motive fluid, such as water, is circulated through motive loop 835 at a desired pressure that is regulated by pump 841. As the motive fluid is forced through condensing vapor-liquid eductor 830, the operation of the eductor creates a partial vacuum that draws vapor from fourth distillation tank 810 (i.e. vapor is drawn through vapor outlet 816 via conduit 823), which facilitates distillation within tank 810. The vapor drawn from fourth distillation tank 810 is entrained into the motive fluid circulating through loop 835 and is condensed to become part of the motive fluid. In one or more embodiments, the motive fluid entering eductor 830 adequately absorbs the heat of condensation of the vapor drawn into condensing eductor 830 to thereby condense the vapor. As the skilled person appreciates, several factors can contribute to the ability of the motive fluid to overcome the heat associated with the vapor including, but not limited to, the temperature and volume of the motive fluid being mixed with the vapor

With reference again to the distillation tanks, at least a portion of the heat associated with the vapor drawn from tank 610, including latent heat released by the condensation of the vapor within radiator 650, is transferred to the concentrated brine with third tank 710. The temperature of the liquid within distillation tank 710, as well as the pressure within tank 710 (which is regulated by vapor being drawn into radiator 750), drive separation of the water vapor from the brine within tank 710. Stated differently, temperature and pressure within tank 710 drive further distillation of the concentrated brine within tank 710, and the distillate (i.e. vapor) is removed from the head space through vapor outlet 716 through conduit 715, and the residue, which is concentrated brine, is removed from tank 710 via concentrated brine outlet 714 via conduit 713 to fourth distillation tank 810 via inlet 812.

Similarly, at least a portion of the heat associated with the vapor drawn from tank 710, including latent heat released by the condensation of the vapor within radiator 750, is transferred to the concentrated brine with third tank 810. The temperature of the liquid within fourth distillation tank 810, as well as the pressure within tank 810 (which is regulated by vapor being drawn into eductor 830), drive separation of the water vapor from the brine within tank 810. Stated differently, temperature and pressure within tank 810 drive further distillation of the concentrated brine within tank 810, and the distillate (i.e. vapor) is removed from the head space through vapor outlet 816 through conduit 823, and the residue, which is concentrated brine, is removed from tank 810 via concentrated brine outlet 818.

Depending on the desired concentration of the concentrated brine, the concentrated brine can be removed from system 500 via outlet 618, 718, and/or 818, and it can then be routed to downstream uses or disposal as described herein. The location at which it may be desirable to remove the concentrated brine from the brine concentration system may depend on several factors including, but not limited to, the total solids (both dissolved and suspended) within the concentrated brine at any given location. In this regard, each distillation tank may include a device to monitor one or more properties of the brine to ascertain the total solids and/or one or more other relevant properties such as viscosity. Removal of the brine through one or more of the discharge outlets may take place, based upon data gathered relative to the brine, by decisions made in real time or via a pre-selected program.

It will be appreciated that as the concentration of the brine increases with each stage (i.e. as the concentrated brine solution is transferred to each successive distillation tank), the conditions required to distill the solution increase by requiring higher temperatures or reduced pressure. In one or more embodiments, the temperature of the solution within each successive tank decreases and the pressure within each successive tank decreases. Stated differently, the temperature of the initial distillation tank can be represented by Tᵢₙᵢₜᵢₐₗ and the pressure within initial distillation tank can be represented by Pᵢₙᵢₜᵢₐₗ; the temperature of the intermediary distillation tanks (collectively) can be represented by T_{intermediary} and the pressure within the intermediary distillation tanks (collectively) can be represented by P_{intermediary}; the temperature of the final distillation tank can be represented by T_{final}, the pressure within the final distillation tank can be represented by P_{final}, and during operation of the system, Tᵢₙᵢₜᵢₐₗ>T_{intermediary}>T_{final} and Pᵢₙᵢₜᵢₐₗ>P_{intermediary}>P_{final}. In one or more of these embodiments, Pᵢₙᵢₜᵢₐₗ is above atmospheric pressure, and P_{final} is below atmospheric pressure. In these or other embodiments, P_{intermediary} is above atmospheric pressure, in other embodiments at or near atmospheric pressure, and in other embodiments, below atmospheric pressure. Where the intermediary stage includes multiple substages (i.e. multiple distillation tanks in series with heat of condensation and concentrated brine transferred successively downstream to the tanks in series), the temperature and pressure at the first substage can be represented as T₁ and P₁, respectively, and each successive stage as T₁₊ₙ and P₁₊ₙ, respectively, where n represents the number of the sub-stage beyond the first substage. Accordingly, during operation of the system, the temperature and pressure profile within the intermediary stage can be defined as T₁>T₁₊ₙ and P₁>P₁₊ₙ, with n being an integer representing each successive substage beyond the first and continuing in series for each additional substage. In one or more embodiments, P₁ and P₁₊ₙ are all at or below atmospheric pressure. In other embodiments, P₁ is at or above atmospheric pressure, and P₁₊ₙ are each below atmospheric pressure.

### INDUSTRIAL APPLICABILITY

The systems and processes of the present invention can be employed to treat a variety of salt solutions. In one or more embodiments, treatment of the solutions produces a distillate stream that is substantially free of dissolved solids and a concentrated brine stream that includes total dissolved solids that are substantially greater than the feed stream (i.e. the salt solution fed to the process). In one or more embodiments, the distillate stream includes less than 5000 mg/L, in other embodiments less than 1000 mg/L, in other embodiments less than 100 mg/L, in other embodiments less than 10 mg/L, and in other embodiments less than 1 mg/L of dissolved solids.

As indicated above, the salt solutions that are treated according to the present invention include aqueous solutions that include dissolved solids. For example, these salt solutions can include greater than 1000 mg/L, in other embodiments greater than 10,000 mg/L, in other embodiments greater than 25,000 mg/L, in other embodiments greater than 50,000 mg/L, and in other embodiments greater than 100,000 mg/L total dissolved solids. These salt solutions may also include suspended solids. Exemplary salt solutions that can be treated according to the present invention include, without limitation, brackish water, brine water, sea water, playa lake water, closed-basin water, mineral water, industrial process water, sea water contaminated with salt solutions, produced water, and weighted brine. These salt solutions can include naturally-occurring salt solutions or contaminated salt solutions, where the latter refers to man-made salt solutions or salt solutions that are formed by the introduction of one or more species into a naturally occurring salt solution (e.g. a sea water contaminated with a weighted brine). In one or more embodiments, the salt waters treated by the systems and processes of the present invention include hydrocarbon materials entrained in the water; e.g. they may include entrained or suspended oils. In these or other embodiments, the salt waters may include volatiles such as, but not limited to, volatile organics and ammonia.

As indicated above, one or more advantageous aspects of the invention include the fact that the methods and systems of the invention can be used to concentrate salt solutions and thereby produce a concentrated salt solution. These concentrated salt solutions can then advantageously be directed to one or more downstream handling operations. It will be appreciated that the concentrated solutions have reduced volume relative to the initial salt solutions that are treated by the present invention and that several advantages stem from this reduced volume.

For example, in those embodiments where the salt solutions are targeted for disposal (e.g. where the salt solutions are considered waste water), the concentrated salt solutions can be more efficiently disposed of. The skilled person will appreciate that reduced volumes will lead to reduced disposal costs. Also, the reduced volumes will necessarily be less taxing on disposal capacity.

Other exemplary targeted uses of the concentrated salt solutions include the extraction of desired metal ions from the concentrated salt solutions (i.e. metal ion reclamation). The skilled person will appreciate that as the salt solutions are concentrated, the weight of ions increases per unit volume. Stated differently, concentration of salt solutions decreases the volume of water that must be handled and/or processed to extract a given amount of desired metal ion. Therefore, while it may otherwise be cost prohibitive to extract metal ions, such as lithium or rare-earth metals, from many salt solutions due to the high cost of handling and/or processing the volumes of water that may be required to handle and process less concentrated salt solution, the systems and processes of the present invention advantageously provide concentrated salt solutions that can yield higher recovery of the targeted ion relative to the volume of water handled and/or processed.

In other exemplary uses, the concentrated brines are re-used in drilling and producing oil and gas. For example, this may include use in fluid for hydraulically fracturing a subterranean formation via a well, or in enhanced oil recovery operations.

As indicated above, aspects of the invention provide for the management of produced water streams. As the skilled person understands, water associated with the production of oil and gas is referred to as produced oilfield water or simply produced water. Produced water is generally classified as flowback water or formation water. Flowback water includes spent hydraulic fracturing (frac) fluid, which includes water and related additives used to hydraulically fracture the formation. Formation water includes water that was originally present in the formation.

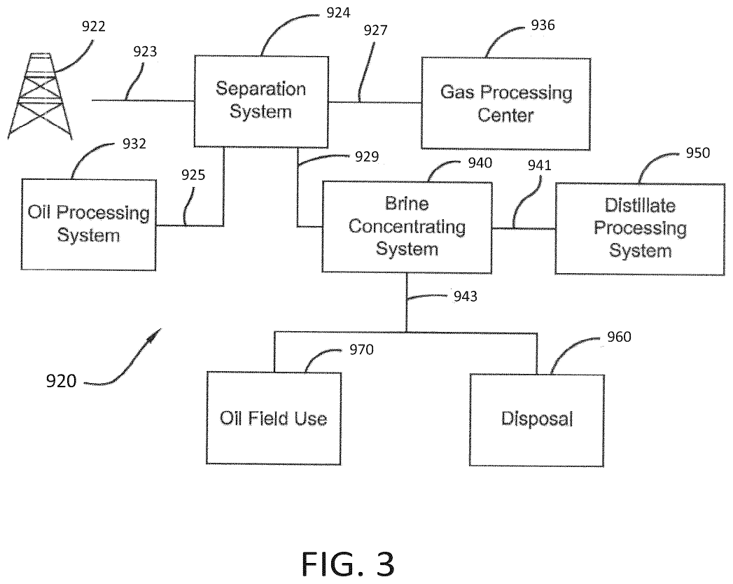

The water management methods of the present invention can be described with reference to FIG. 3, which depicts system 920 including one or more oil and/or gas production wells 922 that provide a multiphase production stream carried by conduit 923. The multiphase production stream generally includes a mixture of liquids and gases that include hydrocarbons (e.g. one or more of gas, condensate, and oil), water (which may further include dissolved minerals, such as salt), other gases (e.g. nitrogen, carbon dioxide (CO2), hydrogen sulfide (H2S)), and solids (e.g. salt, sand, and scale). Conduit 923 routes the multiphase production stream to a separator system 924, which ultimately separates the stream into an oil-rich stream that can be carried by conduit 925, a gas-rich stream that can be carried by conduit 927, and a water-rich stream that can be carried by conduit 929. Practice of this invention is not necessarily limited by the workings of separator system 924. For example, and as the skilled person understands, separator system 924 may include a multi-stage arrangement that may include a two-phase separator that produces a gas-rich stream and a liquid-rich stream. The liquid-rich stream may then subsequently be separated by a liquid-liquid separator to provide the oil-rich stream and the water-rich stream. Alternatively, three-way separators may by employed to produce the gas-rich, water-rich, and oil-rich streams. The oil-rich stream can then be routed, via conduit 925, to an oil-processing system 932 where the oil-rich stream may be treated in a conventional manner for subsequent use or sale. The gas-rich stream can be routed, via conduit 927, to a conventional gas processing center 936 to be treated and managed.

In accordance with the present invention, the water-rich stream, which may be referred as a produced water stream, is routed to a brine-concentrating system 940 via conduit 929. It will be appreciated that brine-concentrating system 940 can include a distillation system of one or more embodiments of the present invention. It will also be appreciated that the water-rich stream can be pre-treated prior to being treated within the brine-concentrating systems of the present invention. For example, the water-rich stream can undergo further separations to remove hydrocarbons entrained with the water-rich stream. In one or more embodiments, the process of the present invention includes treating the water-rich stream to provide a stream that includes less than 3 wt %, in other embodiments less than 2 wt %, and in other embodiments less than 1 wt % hydrocarbon based on the total weight of the water-rich stream, prior to treating the water-rich stream within the distillation systems of the present invention.

Within brine-concentrating system 940, the water-rich stream undergoes distillation to provide a distillate stream and a residue stream, which may also be referred to as a highly-concentrated brine stream. The distillate stream can be carried by conduit 941 to a distillate processing center 950 where, for example, further processing may take place to produce a purified water stream. In one or more embodiments, the distillate stream can be routed back to an oil field for use as will be described in greater detail below. The residue stream, which is carried by conduit 943, can be handled in one or more ways as described above; e.g. disposed of, re-used, or subjected to ion reclamation. For example, the highly-concentrated brine stream can be routed to disposal 960, which may include well disposal. In combination therewith or in the alternative, the highly-concentrated stream can be routed to an oil field 970 for use therein. For example, the highly-concentrated brine stream can be used in frac make-up water or in enhanced oil recovery operations. In other embodiments, the concentrated solutions can be further processed to recover metal ions.

In one or more embodiments, distillation is controlled to produce a concentrated brine stream that is greater than 2.0 time, in other embodiments greater than 4.0 times, in other embodiments greater than 5.0 times, in other embodiments greater than 6.0 times, in other embodiments greater than 7.0 times, and in other embodiments greater than 8.0 times the amount of total dissolved solids (TDS) as the produced water stream originally fed to the brine-concentrating step or system. In one or more embodiments, distillation is controlled to produce a concentrated brine stream that includes greater than 25,000 mg/L, in other embodiments greater than 50,000 mg/L, in other embodiments greater than 100,000 mg/L, in other embodiments greater than 150,000 mg/L, and in other embodiments greater than 200,000 mg/L total dissolved solids. Stated differently, distillation is controlled to produce a concentrated brine stream having a volume that is about 90% or less, in other embodiments about 77% or less, in other embodiments about 67% or less, in other embodiments about 50% or less, in other embodiments about 43% or less, in other embodiments about 40% or less, and in other embodiments about 33% or less of the volume of the produced water stream that is originally fed to the brine-concentrating step or system.

While the systems and methods of the present invention produce concentrated brine streams, the degree of concentration (e.g. distillation) is also controlled to produce a concentrated brine stream that remains below threshold levels for total solids (i.e. dissolved and/or suspended solids) to ensure the ability to handle the residue stream in a desired manner. For example, it may be desirable to maintain the total solids below levels necessary to maintain fluidity and the ability to pump the concentrated brine stream. For example, the total solids are maintained below levels to provide the concentrated brine stream with a Bingham Plastic viscosity of less than 100 centipoise (cP), in other embodiments less than 50 cP, and in other embodiments less than 25 cP. Suitable methods for determining the Bingham Plastic viscosity of the concentrated brine stream can be found in Chapter 4 of The Society of Petroleum Engineers Monograph Volume 4, Cementing by Dwight K. Smith, published in 1976 and the American Petroleum Institute (API) Recommended Practice 13B-1, 2^{nd}, edition, Standard Procedure for Field Testing Water-Based Drilling Fluids.

In other embodiments, the total dissolved solids are maintained below the saturation point of the concentrated brine solution. For example, the total dissolved solids of the concentrated brine solution can be maintained at less than 400,000 mg/L, in other embodiments less than 350,000 mg/L, in other embodiments less than 300,000 mg/L, and in other embodiments less than 250,000 mg/L. In one or more embodiments, the upper limit of the total dissolved solids content of the concentrated brine solution is entirely dependent upon the nature of the dissolved solids content of the influent water being distilled. For instance, the saturation content of a sodium chloride (NaCl) solution is about 26% (i.e., 260,000 mg/L) having a relative viscosity of 1.986, whereas the saturation content of a calcium chloride solution is about 40% (i.e., 400,000 mg/L) having a relative viscosity of 8.979. Seawater, by contrast, is not only a mixed salt solution, but has a dissolved solids content substantially less than that of a saturated sodium chloride or calcium chloride solution. As such, seawater has a salt content of about 3.5% (35,000 mg/L) and a relative viscosity of 1.067. An increase in the salinity of the concentrated seawater brine solution of approximately 1.71 times to 6% (i.e., 60,000 mg) would yield a relative viscosity of the brine of 1.137 cP. As the skilled person appreciates, relative viscosity is defined as the ratio of the absolute viscosity of a solution at 20° C. to the absolute viscosity of water at 20° C. (Weast, CRC Handbook of Chemistry and Physics, 57^{th} ed., pg. D-218). The skilled person also appreciates that the absolute viscosity of brine solutions does not take into consideration suspended solids (Bingham plastic) effects, or gelation and/or emulsification effects produced by the carry-over of polymers, polymeric residue, and/or hydrocarbons (Power Law effects), which may substantially increase the viscosity of the concentrated brine product.

In one or more embodiments, the concentrated brine exiting the brine concentrating system 940 can be diluted to maintain operational flexibility. For example, the concentrated brine can be diluted using distillate (e.g. distillate carried by conduit 941 from brine concentrating system 940). In other embodiments, the concentrated brine can be diluted with the water-rich stream carried by conduit 929 into brine concentrating system 940 (i.e., the concentrated brine stream can be diluted with the inlet stream). In one or more embodiments, the concentrated brine can be filtered prior to delivering the stream to downstream handling such as disposal.

In one or more embodiments, the distillation process may include a continuous distillation process that can be adjusted in real time to provide a residue stream with a desired concentration of total solids (i.e. dissolved and/or suspended solids). According to these embodiments, the total solids of the produced water stream is determined before distillation. Likewise, the total solids of the concentrated brine stream (i.e. the residue stream) is determined following distillation. In view of this information, the distillation is adjusted to provide the desired residue stream. As the skilled person appreciates, several methods and techniques can be used to determine the dissolved and/or suspended solids content of either the produced water stream or the concentrated brine stream. For example, the skilled person understands that standardized testing for dissolved solids is provided at Section 2520, Standard Methods for the Examination of Water & Wastewater, 21^{st} ed., 2005, and standardized testing for suspended solids is provided at Section 2540, Standard Methods for the Examination of Water & Wastewater, 21^{st} ed., 2005. It will also be appreciated that total dissolved solids is often determined by electrical conductivity testing, which affords the opportunity to continuously monitor and provide real-time data on the dissolved solids content of solutions. Also, suspended solids can be determined based upon the turbidity of the water (e.g. ISO 7027 by measuring the incident light scattered at right angles from the sample). In yet other embodiments, distillation can be adjusted based upon information obtained relative to the viscosity of the concentrated brine solution. In those embodiments that include multiple stages of separation, the processes of the invention may include a determination of temperature, pressure, and brine concentration at each stage.

The systems and process designs of the present invention advantageously allow for large scale treatment of water. For example, the systems and processes of the present invention, especially fixed-base systems, are adapted to treat greater than 25,000, in other embodiments greater than 50,000, and in other embodiments greater than 100,000 barrels of salt solution per day. In other embodiments, the processes and systems of the invention can be configured to treat lower volumes of salt solutions, including those systems designed to treat from about 500 to about 25,000 barrels per day. These small systems may advantageously be configured and carried by road-rated mobile units.

Various modifications and alterations that do not depart from the scope and spirit of this invention will become apparent to those skilled in the art. This invention is not to be duly limited to the illustrative embodiments set forth herein.

1. A multi-stage process for treating a salt solution, the process comprising:
(i) providing an initial salt solution to an initial distillation stage,
(ii) distilling the initial salt solution within the initial distillation stage to thereby produce an initial vapor stream and an initial concentrated salt solution, where said initial distillation stage takes place at pressure above atmospheric pressure;
(iii) transferring the initial vapor stream and initial concentrated salt solution to an intermediary distillation stage;
(iv) condensing the initial vapor stream to thereby release the heat of condensation associated with the initial stream;
(v) converting, within the intermediary distillation stage, at least a portion of the initial concentrated salt solution an intermediary vapor stream and an intermediary concentrated salt solution;
(vi) transferring the intermediary vapor stream and intermediary concentrated salt solution to a final distillation stage, wherein the final distillation stage produces a final vapor stream and a final concentrated salt solution;
(vii) condensing at least a portion of the final vapor stream to thereby release the heat of condensation associated with the final vapor stream;
(viii) transferring at least a portion of the heat of condensation associated with the final vapor stream to the initial salt solution; and
(ix) capturing at least a portion of the final concentrated salt solution.

2. The multi-stage process for treating a salt solution of claim 1, where the intermediary distillation stage includes a first substage wherein heat of condensation associated with the initial stream is transferred to the initial concentrated salt solution and the initial concentrated salt solution is distilled to produce a first substage vapor stream and a first substage concentrated salt solution, where the first substage vapor stream is condensed to thereby release the heat of condensation associated with the first substage vapor stream, and where the intermediary distillation stage includes a second substage wherein the heat of condensation associated with the first substage vapor stream is transferred to the first substage concentrated salt solution and the first substage concentrated salt solution is distilled to produce a second substage vapor stream and a second substage concentrated salt solution.

3. The multi-stage process for treating a salt solution of claim 2, where said second substage vapor stream is said intermediary vapor stream, and where said second substage concentrated salt solution is said intermediary salt solution.

4. The multi-stage process for treating a salt solution of claim 2, wherein said intermediary distillation stage further includes a third substage wherein heat of condensation associated with the second substage vapor stream is transferred to the second substage concentrated salt solution and the second concentrated salt solution is distilled to produce a third substage vapor stream and a third substage concentrated salt solution.

5. The multi-stage process for treating a salt solution of claim 4, where said third substage vapor stream is said intermediary vapor stream, and where said third substage concentrated salt solution is said intermediary salt solution.

6. The multi-stage process for treating a salt solution of claim 4, wherein said intermediary distillation stage further includes a fourth substage wherein heat of condensation associated with the third substage vapor stream is transferred to the third substage concentrated salt solution and the third concentrated salt solution is distilled to produce a fourth substage vapor stream and a fourth substage concentrated salt solution.

7. A system for treating a salt solution, the system comprising:
(i) a first distillation tank, where said first distillation tank is adapted for pressure regulation and includes an inlet for receiving a salt solution, an outlet for removing a first concentrated salt solution, and an outlet for removing vapor, where said first distillation tank operates at pressures above atmospheric pressure;
(ii) a second distillation, where said second distillation tank is adapted for pressure regulation and includes an inlet for receiving a concentrated salt solution, an outlet for removing a concentrated salt solution, and an outlet for removing vapor, where said second distillation tank is downstream of said first distillation tank, and where said second distillation tank operates at pressures below atmospheric pressure;
(iii) a first heat exchanger in thermal communication with the first distillation tank;
(iv) a second heat exchanger in thermal communication with the second distillation tank; and
(v) a first eductor in fluid communication with the second distillation tank, where said first eductor includes an inlet for receiving a liquid motive fluid, an inlet for receiving vapor from the second distillation tank, and an outlet for removing a first heated fluid stream from the first eductor, where the first eductor is adapted to mix vapor from the second distillation tank into the motive fluid to thereby condense the vapor to produce the first heated liquid stream, where outlet for removing a first heated fluid stream is in fluid communication with said first heat exchanger.

8. A method of managing a salt solution, the method comprising:
(i) providing an initial salt solution;
(ii) partially distilling the salt solution to provide a distillate stream and a concentrated salt solution; and
(iii) directing the concentrated salt solution to downstream handling.

9. The method of managing a salt solution of claim 8, where said partially distilling includes one or more distillation stages that operate above atmospheric pressure.

10. The method of managing a salt solution of claim 8, where said partially distilling includes two or more distillation stages that operate above atmospheric pressure.

11. The method of managing a salt solution of claim 8, where the salt solution is produced water.

12. The method of managing a salt solution of claim 8, where the concentrated salt solution includes at least 1.1. times the total dissolved solids of the initial salt solution.

13. The method of managing a salt solution of claim 8, where the concentrated salt solution has a Bingham Plastic Viscosity of less than 100 centipoise.

14. The method of managing a salt solution of claim 8, where the concentrated salt solution includes greater than 25,000 mg/L and less than 400,000 mg/L total dissolved solids.

15. The method of managing a salt solution of claim 8, where the concentrated salt solution includes greater than 50,000 mg/L and less than 350,000 mg/L total dissolved solids.

16. The method of managing a salt solution of claim 8, where the initial salt solution has a volume, where the concentrated salt solution has a volume, and where the volume of the concentrated salt solution is about 90% or less than the volume of the initial salt solution.

17. The method of managing a salt solution of claim 8, where directing the concentrated salt solution to downstream handling includes disposing of the concentrated salt solution.

18. The method of managing a salt solution of claim 8, where disposing of the concentrated salt solution includes injecting the concentrated salt solution into a well.

19. The method of managing a salt solution of claim 8, where directing the concentrated salt solution to downstream handling includes introducing the concentrated brine in a formation for oil and gas recovery.

20. The method of managing a salt solution of claim 8, where directing the concentrated salt solution to downstream handling includes mixing the concentrated salt solution into water adapted for hydraulically fracturing a subterranean formation via a well.

21. The method of managing a salt solution of claim 8, where directing the concentrated salt solution to downstream handling includes separating one or more metal ions from the concentrated salt solution.

22. The method of managing a salt solution of claim 8, where directing the concentrated salt solution to downstream handling includes separating lithium ions from the concentrated salt solution.

23. The method of managing a salt solution of claim 8, where directing the concentrated salt solution to downstream handling includes separating rare earth ions from the concentrated salt solution.

24. (canceled)

25. (canceled)

26. (canceled)
